(19) United States
(12) Patent Application Publication
(10) Pub. No.: US 2024/0104363 A1
(43) Pub. Date: Mar. 28, 2024

(54) METHOD AND APPARATUS FOR THE JOINT OPTIMIZATION OF A NEURAL NETWORK AND DEDICATED HARDWARE FOR THE NEURAL NETWORK

(71) Applicant: Robert Bosch GmbH, Stuttgart (DE)

(72) Inventors: Michael Klaiber, Stuttgart (DE); Yannick Braatz, Intschede (DE)

(21) Appl. No.: 18/459,237

(22) Filed: Aug. 31, 2023

(30) Foreign Application Priority Data
Sep. 27, 2022 (DE) 10 2022 210 228.2

(51) Int. Cl. G06N 3/063

(52) U.S. Cl. CPC G06N 3/063

(57) ABSTRACT

A method for ascertaining a performance of a machine learning system on a processing unit. The method includes: creating a hardware model of the processing unit from a provided technical specification of the processing unit and creating a simulation graph based on the machine learning system; simulating an implementation of the machine learning system on the processing unit using the hardware model and the graph, the simulation being an event-based simulation, and ascertaining the performance based on the result of the simulation.

### CROSS REFERENCE

The present application claims the benefit under 35 U.S.C. § 119 of German Patent Application No. DE 10 2022 210 228.2 filed on Sep. 27, 2022, which is expressly incorporated herein by reference in its entirety.

### FIELD

The present invention concerns a method for ascertaining a performance of a neural network on a processing unit and a method for the joint optimization of a neural network configuration and a processing unit for running the neural network with regard to optimizing the hardware performance, as well as an apparatus, a computer program, and a machine-readable storage medium.

### BACKGROUND INFORMATION

The use of deep neural networks (DNNs) on embedded devices is becoming more and more difficult owing to an increasing complexity of the network architectures of the DNNs. In particular, automating the optimization of neural networks (NNs) in the context of hardware-aware neural architecture search (NAS) allows for more powerful DNNs, but at the cost of large numbers of network parameters. Balancing the limited on-chip resources for running DNNs on devices while taking account of millions of design decisions makes it difficult to manually optimize the development of machine learning (ML) accelerator platforms. Design space exploration (DSE) tools guide the search process through the vast area of parameter selection and architecture decisions and facilitate the hardware-software co-design of the algorithm and the accelerator. To accurately evaluate individual design points, these tools utilize prediction methods to estimate the effect of certain parameter decisions on the overall key performance indicator (KPI).

Analytical models provide rapid predictions of the performance of DNNs on ML accelerators, in terms of computational latency, resource utilization or power consumption, for example, by combining NN operator attributes with quantitative hardware parameters such as bandwidth or available chip resources. However, such models are limited to a narrow range of applications in which the hardware behavior is described by simple equations. For more complex architectures, ML-based approaches that train statistical models on the basis of real hardware measurements may be used. By learning dynamic hardware effects, these models are able to accurately predict the accelerator performance for a wide variety of workloads and architectures. This approach has the disadvantage that it requires time-consuming training, however, with a need for real measurement data which are not always available, especially during early phases of the DNN system design.

In order to achieve an optimal hardware performance (e.g., latency, power consumption, throughput) for running neural networks on machine learning accelerators, the limited on-chip resources (memory, processing elements, bus width, etc.) must be weighed against the network requirements. Since, at a hardware and software level, up to several billion decisions have to be considered in a search space, there are tools which automate the process by evaluating certain hardware and software parameter combinations. This is usually done by formulating equations, which may be solved to provide estimates of the system performance with regard to latency, power consumption or resource utilization. Such analytical models consider hardware parameters, such as bandwidth, clock frequency or available resources, and software parameters of the DNNs, such as layer shapes/types or operator dimensions or quantizations. More complex system behavior may be predicted using simulations, but the setup for the simulation environments may involve considerable effort in manually modeling the individual system components.

An object of the present invention is to improve the process of creating simulation environments from the neural network description and the implementation of a hardware/software co-design.

### SUMMARY

The present invention provides an end-to-end methodology for simulation-based performance predictions of DNN (workloads) on ML accelerators. Simulation models are capable of providing more accurate predictions than mathematical equations. The present invention allows the process of creating such models for use in the context of hardware/software co-design to be automated. With more complex hardware/software architectures in particular, an improvement in forecasting accuracy may be achieved in this way. The simulation results obtained from the hardware/software co-design may be used to optimize the neural network parameters and/or the accelerator architecture.

A further advantage is that the automation of the process of creating simulation environments from the definition of the neural network software enables the algorithm and the specialized embedded device on which it is used to be jointly optimized. Changes to parameters at a hardware or software level may be translated directly into simulation setups for verifying the system performance. This leads to customized hardware/software systems for specific applications.

In addition, because of the closed-loop simulation circuit achieved by adjusting hardware parameters of the accelerator and/or software parameters of the DNN according to the simulation results, the present invention enables multiple neural network operator implementations to be validated on multiple DNN design candidates.

Further aspects of the present invention are disclosed herein. Advantageous developments and example embodiments of the present invention are disclosed here.

In a first aspect, the present invention concerns a computer-implemented method for ascertaining a performance of a machine learning system on a processing unit. The processing unit may be a hardware accelerator for the machine learning system. A hardware accelerator enables the load on a main processor of the processing unit to be reduced by delegating specific computationally intensive tasks to hardware designed specifically for such tasks. According to an example embodiment of the present invention, the method may start with an optional step comprising obtaining the machine learning system and a technical specification of the processing unit.

According to an example embodiment of the present invention, this is followed by creating a hardware model of the processing unit from a provided technical specification of the processing unit and creating a simulation graph based on the machine learning system. A simulation graph may be understood to be a graph which characterizes or monitors the execution of the simulation processes. The hardware model may be set up for the individual hardware components, such as DMAs, ALUs, buses or memories, on the basis of hardware elements that are defined in the technical specification. In other words, simulation graphs for optimizations of neural networks on dedicated hardware accelerators are generated automatically.

According to an example embodiment of the present invention, this is followed by simulating an implementation of the machine learning system on the processing unit using the hardware model and the simulation graph, the simulation being an event-based simulation. Modeling by way of an event-based simulation framework has the advantage that it enables the blocking behavior of individual operations on the hardware and the execution thereof on hardware to be modeled.

According to an example embodiment of the present invention, this is followed by ascertaining the performance based on the result of the simulation. The performance may be an execution latency of the simulation. Operations on the hardware are assigned latencies according to their configuration, and these latencies are then summed during the simulation process. At the end of the simulation, this sum may be output as the performance prediction.

According to an example embodiment of the present invention, it is provided that the machine learning system be a neural network, a neural network graph being converted into a tree representation by a machine learning compiler during the step of creating the simulation graph. The tree representation characterizes an execution sequence of all associated network graph hardware operations, while the leaves describe micro-details of the operations, such as the type of hardware operation (e.g., loading, storing, computing) together with relevant information (inputs, outputs, addresses, data types). The tree representation is preferably converted into a graph, specifically a Petri net graph.

Petri net graphs allow the execution sequence of processes to be modeled by expressing them as nodes in a tree-like structure, the nodes being connected by edges and being able to store tokens. Nodes have to wait until a fixed number of tokens are available at their input connection before being enabled by taking the tokens from this connection. On completion of the associated task, they place some tokens at the output connection so that subsequent nodes may be executed. The blocking behavior of hardware processes may be expressed via this design methodology.

Machine learning compilers like TVM are able to express the original neural network graph in an internal tree representation. The use of the tree representation together with all associated information enables simulation graphs to be created for a suitable hardware execution description.

It is further provided according to an example embodiment of the present invention that internal hardware processes be simulated with an event-based simulation, whereby hardware blocks come to a stop when functions of other components have to be ended, before the actual execution may be started. Hardware processes may be understood to be a loading/storing of data from/in various areas of the memory hierarchy, or the processing of these data in processing units.

In a second aspect of the present invention, a computer-implemented method is proposed for the joint optimization of a neural network configuration and a processing unit for running the neural network with regard to optimizing the hardware performance and preferably the performance of the neural network. The performance of the neural network may characterize a reliability and/or accuracy of results ascertained with the neural network.

In addition to the method steps of the first aspect of the present invention, the ascertained performance is used to determine whether parameters characterizing the neural network and/or parameters characterizing the processing unit are adjusted within a predefined parameter range of the parameter in question. If the parameters have been changed, then steps of creating and running the simulation and of ascertaining the performance are carried out again based on the modified parameters. It is possible for the method to be repeated several times until a predefined target performance of the processing unit and/or of the neural network is achieved.

Hardware performance may be understood to be a latency time, a power consumption and/or a throughput. The parameters characterizing the processing unit are, for example, memory size, data processing units, bus width, bandwidth and/or a clock frequency. The parameters characterizing the neural network are, for example, layer types, layer sizes and/or quantizations. Parameters of the processing unit or of the neural network may be changed within a fixed range, and this has a direct impact on the capabilities of the components and on the general hardware model.

According to an example embodiment of the present invention, it is further provided that, once the target performance is achieved, a processing unit be manufactured and/or configured in accordance with the parameters characterizing the neural network and parameters characterizing the processing unit with which the simulation achieved the target performance.

In a third aspect of the present invention, the machine learning system, particularly the neural network, of the first or second aspect of the present invention is an (image) classifier or object detector or semantic segmentation.

In a further aspect of the present invention, a use of the machine learning system of the third aspect of the present invention as a classifier for classifying sensor signals is provided. According to an example embodiment of the present invention, the classifier is taken over using the method according to one of the above-described aspects of the present invention, with the following steps: receiving a sensor signal which includes data from the image sensor, determining an input signal which is dependent on the sensor signal, and feeding the input signal into the classifier in order to obtain an output signal which characterizes a classification of the input signal.

The image classifier associates an input image with one or more classes of a predefined classification. Images of nominally identical, mass-produced products may be used as input images, for example. The image classifier may be trained, for example, to associate the input images with one or more of at least two possible classes which represent a quality assessment of the product in question.

The image classifier, for example a neural network, may be equipped with a structure such that it is trainable to identify and to distinguish pedestrians and/or vehicles and/or traffic signs and/or traffic lights and/or road surfaces and/or human faces and/or medical anomalies in imaging sensor images, for example. Alternatively, the classifier, for example a neural network, may be equipped with a structure which is trainable to identify spoken commands in audio sensor signals.

The term “image” encompasses in principle any distribution of information arranged in a two-dimensional or multi-dimensional grid. This information may be intensity values of image pixels which were recorded using any type of imaging means, such as an optical camera, a thermal imaging camera, or ultrasound, for example. However, any other type of data, such as audio data, radar data or LIDAR data, for example, may also be translated into images and then classified in the same way.

In further aspects, the present invention concerns an apparatus and a computer program, which are each equipped to carry out the above methods, and a machine-readable storage medium on which this computer program is stored.

Specific embodiments of the present invention are described in detail below by reference to the figures.

### BRIEF DESCRIPTION OF THE DRAWINGS

FIG. 1 schematically shows steps for compiling operators of neural networks at a software level in simulation environments, according to an example embodiment of the present invention.

FIG. 2 schematically shows an execution graph and a Petri net graph of a layer of a neural network, according to an example embodiment of the present invention.

FIG. 3 schematically shows an exemplary embodiment for the joint optimization of a neural network and a hardware accelerator of the neural network, according to an example embodiment of the present invention.

### DETAILED DESCRIPTION OF EXAMPLE EMBODIMENTS

Estimating performance when running DNN workloads on ML accelerators requires a precise trade-off between prediction time (speed), bandwidth of the scenarios which the estimation model is able to handle (complexity), and overhead when setting up the underlying technologies (flexibility).

The methodology according to an example embodiment of the present invention uses simulation models to cover the behavior of the hardware architecture for a variety of applications, taking into consideration a variety of supported data flows, memory hierarchies and platform topologies of various DNN hardware/software systems. Flexibility in adjusting to these features may be achieved through the use of hierarchies. The hierarchies may be understood as follows: details of hardware processes are not described at the level of individual instructions but instead are expressed as functions which reproduce the essence of this behavior but are much faster, since not every individual process step has to be executed; rather, the entirety of the process steps is described by this function.

At a hardware level, the use of virtual prototypes to describe the accelerator architecture allows for a rapid execution of hardware operations in comparison to device implementation or RTL simulation, while changing the system configuration requires very little effort. Integrating ML compilers into the build process for simulation environments enables execution graphs for running the simulation on the virtual hardware to be generated directly from the description of the DNN.

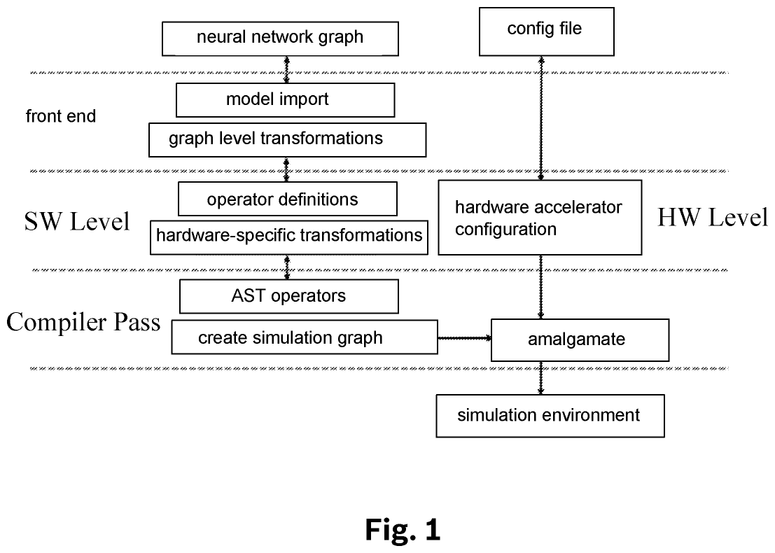

FIG. 1 shows, by way of example, a method for compiling neural network architectures/accelerators in software for a simulation environment which simulates an execution of the neural network on virtual hardware models of the accelerator. The compiler enables hardware-related changes to be made to the neural network kernels, such as loop tiling, unrolling, etc. Translating these kernels into hardware-enabled execution graphs and automatically mapping them between graph nodes and components of virtual hardware platforms allows for a continuous compilation, from user definition through to complete simulation setup.

Representing a neural network kernel flow through computation and communication units of an accelerator architecture with simulation graphs provides levels of process details such as parallelization or pipelining that pure software descriptions are unable to express. It is proposed that Petri nets be used as the basis for constructing such graphs, since it has been found that they enable the blocking behavior and the underlying mechanism to be expressed with precision. For more information about Petri nets, see. for example. the paper by Alexandre V Yakovlev and Albert M Koelmans; 1996; “Petri Nets and Digital Hardware Design’” in Advanced Course on Petri Nets. Springer, 154-236.

This design methodology may be used to describe a variety of data flows, the SimPy open source framework preferably being used for the implementation thereof.

SimPy is an event-based simulation framework in Python which uses events in a similar way to SystemC to synchronize function executions. Processes are functions which are connected to events that arise in other functions. Resources are objects to which processes have mutual access. Events and processes that are able to access shared resources at the same time are enqueued in simulation environments, the simulation being performed by executing the elements in the queue in a manner similar to the behavior of the SystemC simulation kernel.

In a preferred specific embodiment, “places” are defined on the basis of SimPy resources for loading/storing tokens from/until and for blocking when these transfers are denied. In addition, “transitions”, which execute blocking processes to put tokens in/get tokens from adjacent places, may be defined in conjunction with the “places”. This provides an effective modeling method for representing various operator schedules. Associating transitions with hardware operations of neural network kernels, the structure of whose connections via places defines the execution sequence and the timing, creates the simulation graph, which represents the behavior of the kernel when processed on the hardware from the software perspective.

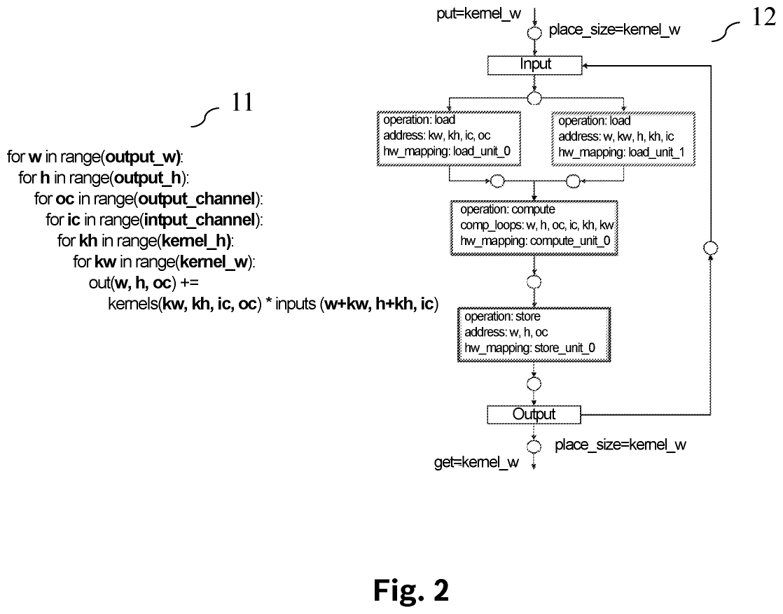

FIG. 2 shows how a convolution kernel of a neural network may be expressed by an execution graph (11). It should be noted that, for the sake of simplicity, only the innermost loop (kernel_w) is shown in this example. Higher loop levels would appear as additional places, connected by an edge on the return path, at the start and end of the graph. In this example, data are moved by way of DMA transfers directly from the main memory into the processing unit, which performs the matrix multiplication. The loading of the input data and kernel data is parallelized, so the compute node block is blocked until data from both DMA transactions are available. On completion of the computational process, a DMA saves the computed output data back to the main memory. The entire load-compute-store sequence is performed kernel_w times, driven by the recursive loop enclosing the hardware nodes. Circles within the graph represent places of a particular size, which means that they are able to store up to a fixed amount (=size) of tokens that were provided by previous transitions. All transitions (squares) are connected by places. In order to be enabled, a transition seeks to get a fixed number of tokens from the input place(s), defined by the parameters get and stalls, until the specified number of tokens is available at the place(s). After successfully obtaining all the necessary tokens, the transition executes the associated hardware operation and transfers the number of tokens indicated by put to the output place to wait until new tokens are executed again at the input. If the output place is already storing the maximum number of tokens, the transition is stopped at the output until there is sufficient space in the place. This blocking behavior may occur, for example, if the computational process is much slower than the loading of new data, which is generally the case in compute-bound systems. In the example, kernel_w tokens are available directly at the input node of the load transitions, so theoretically they could execute kernel_w times. However, since there is also a return path from the output node, tokens must be available at all the places that are connected to the input node before the data load is enabled. Since the place on the return path is initialized with 1 token, the loads at the input are enabled once and thereafter only once the entire load-compute-store sequence has been completed. This structure may be used to model the execution of load-compute-store sequences which are repeated for the entire loop nest. More complex execution scenarios may be expressed by changing the loop nest structure. The insertion of load operations into different stages of the loop nest may represent the movement of data between different levels of the memory hierarchy, while the unrolling of loops leads to the parallel execution of loop body operations. The choice of place sizes, together with put and get values, also has consequences for the hardware behavior. If, for example, the return path in 2 were to be triggered with a value of 3, then, instead of a purely sequential execution, the load, compute and store processes may run as a pipeline, since the input load may be executed 3 times without stalling, and subsequent operations may start when they are enabled again.

FIG. 2 illustrates a simple example of how hardware concepts from a description at a software level may be expressed using Petri net graphs (12). The translation between these representations may be achieved by using machine learning compilers. It is proposed that the open source framework TVM be used for the entire compilation stack, from the operator definition through to the execution graph.

TVM is an open source compiler stack for applying hardware-related modifications to neural network descriptions from commonly used machine learning frameworks. With the aid of two internal representations (IRs) and IR-specific libraries, transformations may be applied to the entire network graph, for example operator fusion, and to individual operators, whereby the loop nest structure may be optimized with respect to the planned hardware back end.

By mapping graph operations onto simulation kernels that are already included in the compilation flow, the end-to-end prediction of the execution cycles of the kernels on virtual accelerator platforms is possible. The scheduling of neural network operators using TVM-specific libraries is referred to as software level modification. TVM uses the term scheduling to denote an operator computation in which tensors of variable sizes are defined for inputs and outputs together with their mathematical relationships such as addition or multiplication. By using loop level modification, for example the Halide language (Xuan Yang, Mingyu Gao, Qiaoyi Liu, Jeff Setter, Jing Pu, Ankita Nayak, Steven Bell, Kaidi Cao, Heonjae Ha, Priyanka Raina, et al. 2020. International Conference on Architectural Support for Programming Languages and Operating Systems. 369-383), for tiling, unrolling or reordering, it is possible to describe a wide variety of different hardware schedules, starting from the same unchanged computation definition, while the use of TVM's scheduling libraries ensures the correctness of the results. Schedules are represented as abstract syntax trees (ASTs), with for loops of the operator description as nodes, and hardware operations, as load and compute, on their body. Cycling through the graph nodes and edges gives access to the hardware operations and address information. In the scenario shown in FIG. 2, the for loop of the variable kernel_w is represented as a graph node, while the loop body is represented as a store operation and writes the output of the multiplication of 2 data loads back to the main memory. Address information for load and store operations may be computed from the operator indices, while the loop limit determines the repetitions of the operation and the subsequent address values. Compiling the operator schedule into the execution graph generates transitions for the hardware operations on the loop body, enclosed by a return path, with put, get and place size values being derivable from the AST nodes. Collecting information for performing hardware operations, while the correct execution sequence is already defined by the AST structure, allows the execution graph to be generated directly from the tree definition, the process being performed in a completely automated manner by way of TVM's pass infrastructure. By adding specific constructs for parallelism and pipelining to the existing TVM library, it is possible to increase the number of schedules that may be expressed, while providing method-dependent interpretations for creating the simulation graph in relation to these scenarios.

The actual behavior approximation is performed by executing the workload graph on virtual prototypes that emulate the hardware functionality. The mapping of the graph operations onto the virtual prototypes (VPs) occurs during the construction of the simulation graph. Carrying out the mapping in this phase allows the validity of the mapping to be checked before the complete graph is created or the simulation is performed. This saves time, since only valid schedule/hardware configurations are preselected. If the requirements of the graph operations do not match the actual hardware functions, for example if the volume of parallel data to be transferred is greater than the bandwidth of the load units, this is detected immediately.

Virtual hardware classes are defined at the Python level, for example, and this offers not only flexibility when configuring the hardware attributes but also good compatibility with TVM and the interfaces of the simulation graphs. When all the main components in FIG. 1 are represented in the same abstraction, there is only a small overhead when executing the end-to-end flow because no cross-lingual translations are required. The use of SimPy library constructs for the implementation enables the hardware functionality to be expressed in a similar way to transaction-level modeling in SystemC. Processes of hardware elements can wait until the processes of other platform components have been completed in order to emulate blocking behavior such as bus traffic or memory access. The extent to which these processes are effective is limited by a flexible set of hardware attributes, which are all related to the type of hardware. These are configurable from a user-defined configuration file, which may be applied to a number of hardware templates for communication, computation, networking and data storage with respect to modern machine learning accelerator architectures. The allocation of clock cycles to hardware processes, based on the hardware and workload attributes, generates the cycle count for the simulation output, while active and stop cycles of hardware components may be registered for each class. The simulation in the proposed methodology is based on the simulation graph, which depicts the executable software workload as a data flow and the execution sequence of the hardware processes. Operations of the simulation graph which are allocated to a specific hardware block may occupy it within the actual simulation in order to perform the planned graph operation of transferring or computing data. It may be provided that the hardware for a specific task is programmed and set up during runtime; for example, addresses for the transfer of data may be defined accordingly, while the hardware attributes define the scope. All processes of the graph operations or of the mapped hardware elements are enqueued in a common simulation environment and are executed in the order of the SimPy simulation kernel.

A specific embodiment of a methodology for the flexible creation of simulation environments for estimating the latency of DNN workloads on ML accelerators has been presented. The integration of the compiler for machine learning into the planned sequence has permitted the creation of hardware-enabled simulation graphs from the software kernels and direct mapping onto virtual accelerator components in a consistent manner. Having all interfaces on the same language level facilitates interaction between compiler, graph and virtual platform model. The possibility of generating simulation environments for a wide variety of data flow and accelerator architecture combinations facilitates the use of the proposed methodology in the context of hardware/software co-design. The combination of the proposed methodology with TVM's black-box automation tool AutoTVM makes it possible to evaluate a large number of kernel schedules that are based on a cost model trained by way of simulation runs. Since schedule changes and hardware platform changes are carried out at the Python level, there is great potential for performing DSE by evaluating both within the optimization loop.

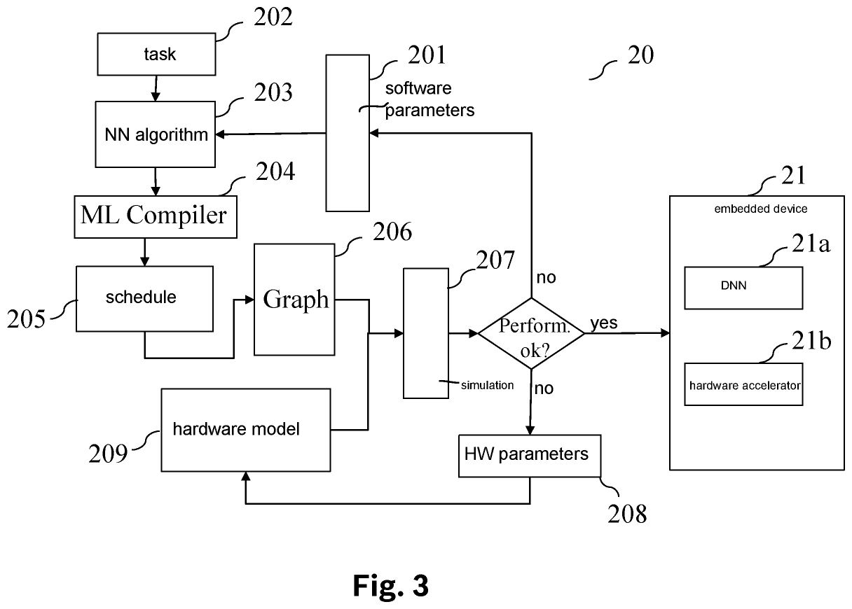

FIG. 3 shows an example of an information flow chart of a specific embodiment of the present invention for optimizing parameters of a DNN (21a) and a hardware accelerator (21b) of the DNN. The DNN (21a) and the hardware accelerator may be used in a mobile device such as an embedded device (21). The mobile device is preferably a sensor, which processes recorded sensor values directly with the DNN (21a), which is run on the hardware accelerator (21b). The sensor is able to perform a pattern recognition with the DNN and using its sensor data.

In a first specific embodiment of FIG. 3, the process may begin with block 202. A task for which the DNN is to be trained, based on a corresponding data set for this task, is set in this block. The training may be carried out in such a way that the DNN is an image classifier or similar, for example. On completion of the training, there is a trained DNN and its architecture in block 203, and this is transferred to a machine learning compiler such as TVM in block 204 and compiled.

In a second specific embodiment of FIG. 3, a pre-trained DNN is provided in block 203.

The schedules for running the DNN may be created using machine learning compilers such as TVM. The integration of the compiler to translate schedules enables new simulation models to be created whenever parameters in the software are changed.

Once the schedule is available in block 205, it is converted into a simulation graph in block 206. As explained above, the simulation graph is preferably a Petri net graph (12). This simulation graph is then provided in block 207 to a simulation, which simulates the behavior of the DNN when it is run on hardware. At the end of the simulation, a performance of the DNN on the hardware is ascertained, based on the behavior of the DNN.

In addition to processing the DNN to obtain the simulation graph for the simulation, as described above, a hardware model of the accelerator (21b) is created in block 209, based on hardware properties of the accelerator (21b).

The hardware model is also provided to the simulation in block 207. The simulation thus precisely simulates the behavior of the DNN on the accelerator.

The simulation in block 207 is preferably an event-based simulation, such as SimPy.

Based on the result of the simulation, a decision may then be made as to whether the performance of the accelerator or of the DNN on the hardware accelerator or the system consisting of the DNN and the hardware accelerator is satisfactory. If the performance is satisfactory, the mobile device (21) may be manufactured and/or configured accordingly. If the performance is not satisfactory, parameters characterizing the DNN and/or parameters characterizing the hardware accelerator may then be adjusted accordingly. In other words, the simulation results provide precise performance assessments with regard to, for example, the latency of the hardware/software system (21), which may be fed back to enable changes to be made to the software and hardware configurations. If, for example, the supply of data to the processing units would take too much time, more bandwidth could be allocated to the communication units of the hardware to enable more data to be made available more quickly.

If the parameters have been changed, the method described above may be repeated in order to carry out a new simulation with the modified hardware model and/or graph. The result is a customized hardware component which is tailored to the optimized execution of the software workload.

These changes often require changes to be made to the software schedule which determines the execution sequence of the supply and computation of data. Repeatedly executing this optimization loop enables the performance to be improved in comparison to general-purpose hardware, while at the same time lowering manufacturing costs. The results of the optimization process determine an optimal hardware system specification.

The possibility of generating new simulation models for modified software schedules enables the present invention to be used in the context of hardware/software co-design.

In the development process for smart devices, it is possible to co-optimize the AI algorithm and the device's hardware by evaluating the effects of parameter changes at both levels in a common simulation environment.

What is claimed is:

1. A computer-implemented method for ascertaining a performance of a machine learning system on a processing unit, comprising the following steps:
creating a hardware model of the processing unit from a provided technical specification of the processing unit;
creating a simulation graph based on the machine learning system;
simulating an implementation of the machine learning system on the processing unit using the hardware model and the simulation graph, the simulation being an event-based simulation; and
ascertaining the performance based on a result of the simulation.

2. The method as recited in claim 1, wherein the machine learning system is a neural network, a neural network graph being converted into a tree representation by a machine learning compiler during the step of creating the simulation graph, the tree representation being converted into a Petri net graph, which is provided to the simulation.

3. The method as recited in claim 1, wherein internal hardware processes are simulated with an event-based simulation.

4. The method as recited in claim 1, wherein the processing unit is a hardware accelerator for the machine learning system.

5. A computer-implemented method for a joint optimization of a neural network configuration and a processing unit for running the neural network with regard to optimizing hardware performance, the optimizing including:
creating a hardware model of the processing unit from a provided technical specification of the processing unit,
creating a simulation graph based on the machine learning system,
simulating an implementation of the machine learning system on the processing unit using the hardware model and the simulation graph, the simulation being an event-based simulation, and
ascertaining the performance based on a result of the simulation;
wherein the ascertained performance is used to determine whether each of the parameters characterizing the neural network and/or parameters characterizing the processing unit are adjusted within a predefined parameter range of the parameter, and wherein the steps of creating, simulating, and ascertaining the performance are carried out again based on the modified parameters, the procedure being repeated several times until a predefined target performance is achieved.

6. The method as recited in claim 5, wherein, once the target performance is achieved, a system is manufactured and/or configured in accordance with the parameters characterizing the neural network and the parameters characterizing the processing unit with which the simulation achieved the target performance.

7. An apparatus configured to ascertain a performance of a machine learning system on a processing unit, the apparatus configured to:
create a hardware model of the processing unit from a provided technical specification of the processing unit;
create a simulation graph based on the machine learning system;
simulate an implementation of the machine learning system on the processing unit using the hardware model and the simulation graph, the simulation being an event-based simulation; and
ascertain the performance based on a result of the simulation.

8. A non-transitory machine-readable storage medium on which is stored a computer program including commands for ascertaining a performance of a machine learning system on a processing unit, the commands, when executed by a computer, causing the computer to perform the following steps:
creating a hardware model of the processing unit from a provided technical specification of the processing unit;
creating a simulation graph based on the machine learning system;
simulating an implementation of the machine learning system on the processing unit using the hardware model and the simulation graph, the simulation being an event-based simulation; and
ascertaining the performance based on a result of the simulation.
